(19) United States
(12) Patent Application Publication
(10) Pub. No.: US 2010/0163321 A1
(43) Pub. Date: Jul. 1, 2010

(54) POWER CONVERTER MODULE FOR A BATTERY-OPERATED VEHICLE

(76) Inventor: Sean K. Goff, Bristol, WI (US)

Correspondence Address: QUARLES & BRADY LLP, 411 E. WISCONSIN AVENUE, SUITE 2040, MILWAUKEE, WI, 53202-4497, US

(21) Appl. No.: 12/346,467

(22) Filed: Dec. 30, 2008

(51) Int. Cl. B60K 6/22

(52) U.S. Cl. 180/65.21; 903/905

(57) ABSTRACT

A power converter module and a battery-operated vehicle which is powered using the power converter module are disclosed. This power converter module may swappable with a battery module that is similarly sized, so that the battery-operated vehicle can selectively run from either the battery module or the power converter module. The power converter module converts fuel into an electrical power supply having a form similar to the power supplied by the battery module.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

This invention relates to battery-operated vehicles. In particular, this invention relates to a power converter module for operating a battery-operated vehicle from fuel.

Many utility vehicles, such as floor scrubbers, are primarily operated indoors. Given their indoor use, such vehicles must operate cleanly and without the production of exhaust. Rather than consuming fossil fuels to produce power for operation, such utility vehicles are conventionally powered by batteries.

However, battery power has a number of drawbacks. The vehicles can only operate as long as the batteries are charged. Once the power is drained from the battery, the battery must be recharged. Recharging requires downtime during which the vehicle can not be used. Further, the length of time between which charges are required may decrease over the life of the battery as the battery degrades.

For some utility vehicles, it may be desirable to operate the utility vehicle both indoors and outdoors. When the vehicle is operated outdoors, it may be permissible to combust fuel to provide the power necessary to operate the vehicle. Although battery power could be used both indoors and outdoors, given the above-stated drawbacks, a more continuous power supply may be desirable that does not require periodic downtime for recharging.

However, implementation of an internal combustion engine in a vehicle that is also battery-powered has proven to be a challenge. U.S. Pat. No. 6,349,545 shows one such hybrid propulsion system and self-propelled vehicle in which an internal combustion engine is periodically run to power a driving motor of a vehicle and charge a battery. When the internal combustion engine is not running, the vehicle runs from battery power. As the power output of the internal combustion engine is not constant, a control means must be used to control and monitor the power provided by the internal combustion engine and divert excess power to the battery or draw the necessary power from the battery for operation.

However, this hybrid vehicle is less energy efficient than a solely battery powered vehicle. Even though the internal combustion engine only periodically runs to operate the vehicle and charge the battery, the internal combustion engine must always be carried by the vehicle. The power required to move this added weight reduces the efficiency of vehicle and results in an increase in the overall consumption of power required to run the vehicle.

Moreover, the additional cost of implementing the control means and the requirement of having both a battery and an internal combustion engine may be undesirable to some purchasers of the vehicle.

Hence, a need exists for an improved vehicle that can alternately run from either a battery or from an internal combustion engine that consumes fuel.

### SUMMARY OF THE INVENTION

A power converter module and a battery-operated vehicle which is powered using the power converter module are disclosed. This power converter module may swappable with a battery module that is similarly sized, so that the battery-operated vehicle can selectively run from either the battery module or from fuel using the power converter module.

The power converter module transforms the mechanical energy from the combustion of fuel in an internal combustion engine into electrical power for the operation of the battery-operated vehicle using a generator. As the power produced by the generator is dirty power, a surge protector in the power converter module smoothes the power supplied by the module as the power passes through the surge protector. The surge protector converts the dirty power into clean power that is provided to the electrical system of the battery-operated vehicle in a manner substantially equivalent to the battery module.

In contrast to many hybrid-type vehicles, the swappable modules allow for the battery-operated vehicle to be run from either fuel using an internal combustion engine (plus the power conversion components) or a rechargeable battery without the necessity of having the vehicle consume extra power to carry both the engine and the rechargeable battery at all times.

These and still other advantages of the invention will be apparent from the detailed description and drawings. What follows is merely a description of a preferred embodiment of the present invention. To assess the full scope of the invention the claims should be looked to as this preferred embodiment is not intended to be the only embodiment within the scope of the claims.

### BRIEF DESCRIPTION OF THE DRAWINGS

FIG. 1 is a perspective view of a battery-operated vehicle with a battery module partially inserted into the battery compartment;

FIG. 2 is a perspective view of a battery-operated vehicle with a power converter module partially inserted into the battery compartment; and

FIG. 3 is a block diagram illustrating the connectivity of the power converter module and the electrical system of the vehicle.

### DETAILED DESCRIPTION OF THE PREFERRED EMBODIMENT

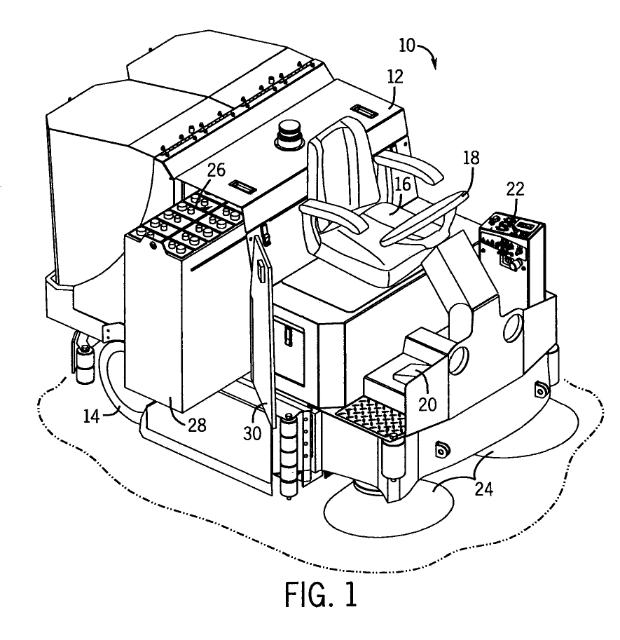

Referring first to FIG. 1, a floor scrubber 10 is shown for cleaning floors. This floor scrubber 10 is the Factory Cat XL Series manufactured by R.P.S. Corporation of Racine, Wis. However, the floor scrubber 10 could be any one of a number of different types of floor scrubbers including, but not limited to, the MiniMag, Magnum, GTX Series, and XR Series, all of which are manufactured by R.P.S. Corporation.

The floor scrubber 10 includes a chassis 12 to which a set of wheels 14 is attached. A seat 16 is located proximate the front end of the chassis 12. Various controls such as a steering wheel 18, a set of operational pedals 20, and a control panel 22 are placed nearby the seat 16, such that they can be accessed by a driver during the seated operation of the vehicle. The floor scrubber 10 also includes various rotary brushes 24 and the like for cleaning a floor.

A battery compartment 26 is formed in the chassis 12 behind the seat 16 for receiving a battery module 28. As shown in FIG. 1, the battery module 28 is being slid into the battery compartment 26. When the battery module 28 is fully inserted into battery compartment 26, the battery module 28 is secured in place and a door 30 is closed to conceal the battery module 28 within the battery compartment 26.

This battery module 28 stores power which can be used to power the floor scrubber 10 during operation. In the form shown, the battery module 28 provides the power to run a drive motor 32 which propels the floor scrubber 10 in the desired direction, to run auxiliary motors that provide the rotation of the rotary brushes 24, and to perform various other functions requiring electricity.

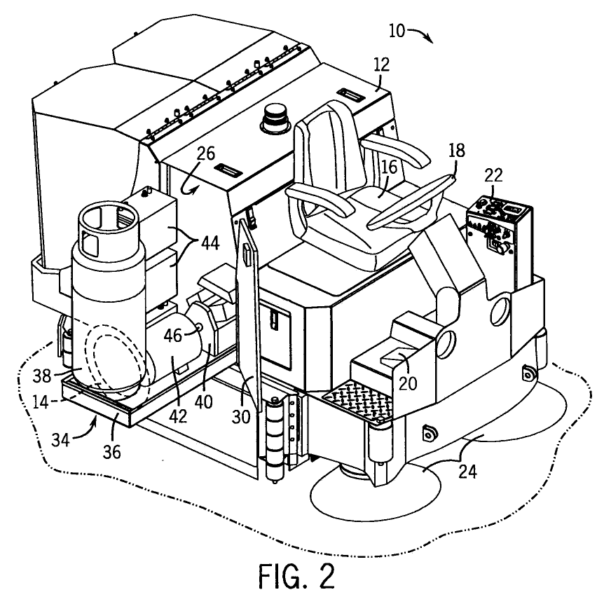

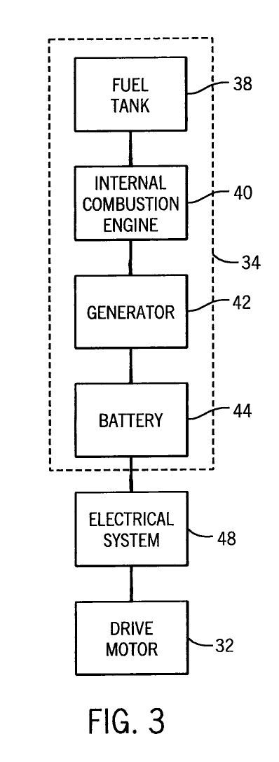

Referring now to FIG. 2, a power converter module 34 is shown being slidably received in the same battery compartment 26 of the floor scrubber 10. The power converter module 34 includes a tray 36 that supports a fuel tank 38, an internal combustion engine 40, a generator 42, and a set of batteries 44. The fuel tank 38 is in communication with the internal combustion engine 40 such that fuel from the fuel tank 38 is provided to the internal combustion engine 40 to operate the internal combustion engine 40. A belt connects a shaft 46 of the internal combustion engine 40 to an input shaft on the generator 42 such that the rotation of the shaft 46 of the internal combustion engine 40 drives the input shaft on the generator 42 via the belt. Each of the shafts have a pulley attached thereto such that a belt and pulley type system transfers the power from the internal combustion engine 40 to the generator 42. The generator 42 is electrically connected to the set of batteries 44. As illustrated in FIG. 3, the connection of the internal combustion engine 40 to the generator 42 to the set of batteries 44 is in series.

Although the tray 36 is shown as supporting all of these components, it is contemplated that any support frame could support the components. In some forms, walls may surround the tray 36 and some or all of the components may be mounted to the walls as well as to the tray 36.

Further, although a belt is described as transmitting the power generated by the internal combustion engine 40 to the generator 42, the internal combustion engine 40 could also directly drive the generator 42 by a common shaft. However, the use of a belt offers protection for the internal combustion engine 40 should the generator 42 seize during operation. In the event that the generator 42 seizes, the belt would wear around the pulleys attached to the shafts rather than damaging the internal combustion engine 40. Further, a belt and pulley type connection between the internal combustion engine 40 and the generator 42 permits different rotations per minute for other generators with only a change in the size of the pulleys attached to the shafts on the internal combustion engine 40 and the generator 42.

Notably, as can be seen comparing FIGS. 1 and 2, the battery module 28 and the power converter module 34 are similarly sized. The battery module 28 has a footprint that is similarly sized to the footprint of the power converter module 34. In particular, the footprint of the tray 36 matches the footprint of the battery module 28. This means that the battery module 28 and the power converter module 34 are swappable with one another.

Referring now to FIG. 3, the power converter module 34 is electrically connected to an electrical system 48 of the floor scrubber 10. The electrical system 48 directs the power generated by the power converter module 34 to the various electrically-powered components of the floor scrubber 10 including the drive motor 32. Alternatively, if the battery module 28 was placed in the battery compartment 26, then the battery module 28 would form an electrical connection with the electrical system 48 of the floor scrubber 10.

Although not shown in the figures, the electrical connection between either the battery module 28 or the power converter module 34 and the electrical system 48 could be formed in a number of ways. The battery module 28 and the power converter module 34 could each have a set of electrical contacts formed thereon that contact a set of electrical contacts in the electrical system 48 of the floor scrubber 10. Preferably, such contacts would be formed in such a manner that only when one of the modules were fully inserted into the battery compartment 26 would the contacts form the electrical connection between the module and the electrical system 48. However, other forms of electrical connection known to those skilled in the art would likewise be suitable to form such an electrical connection between the module and the electrical system 48.

Once the power converter module 34 has been inserted into the battery compartment 26 of the floor scrubber 10, the operation of the device is as follows. The user manipulates one of the controls (i.e., a turn key, a push button or the like) to start the internal combustion engine 40. Typically, a battery (which may be one of batteries 44 or a separate battery for running the internal combustion engine 40) is used to start the ignition of the fuel provided by the fuel tank 38 in internal combustion engine 40. As the internal combustion engine 40 runs, it turns the shaft 46 spins to drive the generator 42. The generator 42 turns the mechanical rotary motion of the output shaft 46 into electric power.

As this power is continuously generated by the internal combustion engine 40 and the generator 42, which do not provide a steady power source, this electric power is “dirty”. As used herein, dirty power refers to power having irregular spikes in current and/or voltage that would make it unacceptable for the direct powering of the electrical system 48 of the floor scrubber 10.

The dirty power is passed through the set of batteries 44 to smooth the electric power into clean power. As used herein, clean power refers to power approximating a DC power supply or the power supplied by the battery module 28 with which the power converter module 34 may be swapped. The set of batteries 44 acts as a pass-though for the electric current to smooth the electric current and effectively act as a surge protector. This provides the clean power necessary to operate the drive motor 32 and other electrical-operated components of the floor scrubber 10 without spikes in supply of power and without brief interruptions in the supply of power.

Essentially, the batteries 44 of the power converter module 34 regulate and provide power to the electrical system 48 of the floor scrubber 10 in a manner substantially equivalent to the battery module 28. By substantially equivalent, it is meant that the power supplied by the power converter module 34 has a form similar to the power supplied by the battery module 28, such that the power converter module 34 is swappable or substitutable with the battery module 28 to power the floor scrubber 10.

It is contemplated that in one form, for power to be supplied to the floor scrubber 10 using the power converter module 34, the internal combustion engine 40 must be run. In this form, the set of batteries 44 need not be charged nor need be capable of holding a charge significant enough to power the floor scrubber 10 independent of the operation of the internal combustion engine 40. This allows for a reduction in the size of the batteries 44, which in turn, reduces the weight of the floor scrubber 10, resulting in increased efficiency.

It is further contemplated that an exhaust path may be provided from the interior of the battery compartment 26 to outside of the floor scrubber 10. Such an exhaust path could be as simple as a slits formed on the side of the body of the floor scrubber 10. However, preferably the exhaust path directs any generated exhaust away from the area in which the user is seated.

It should be appreciated that while a floor scrubber is shown, that this or any other battery-operated vehicle could be powered in the manner described above. It is contemplated that in addition to floor scrubbers, utility vehicles such as floor sweepers, fork lifts, ice resurfacers, and the like could also employ the same system to operate from power provided the combustion of fuel by an internal combustion engine. Moreover, the battery-operated vehicle need not include seating and could be, for example, a walk-behind unit.

Thus, the present invention provides a power converter module and a battery-operated vehicle for use therewith. The power converter module allows for the operation of the operation of the battery operated vehicle from a combustible fuel by swapping a battery module out for a power converter module. This allows the user to have the benefits of a hybrid vehicle (i.e., minimization of the downtime required for recharging and flexibility in method of powering) without many of the disadvantages (i.e., increases in weight for all types power components and cost for components that may not be used by all users of the vehicle).

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A battery-operated vehicle comprising:
a chassis;
a battery compartment formed in the chassis;
a drive motor for propelling the chassis, the drive motor being in electrical communication with the battery compartment via an electrical system;
a power converter module received in the battery compartment, the power converter module including:
a fuel tank;
an internal combustion engine connected to the fuel tank;
a generator connected to and driven by the internal combustion engine; and
a surge protector connected to the generator, the surge protector adapted for connection to the electrical system of the battery-operated vehicle;
wherein, when the internal combustion engine operates and drives the generator, the generator produces power that is then passed through the surge protector for the electrical system of the battery-operated vehicle.

2. The battery-operated vehicle of claim 1, in which a battery module is swappable with the power converter module and the power converter module produces power that is substantially equivalent to the power provided by the battery module.

3. The battery-operated vehicle of claim 2, further comprising a support frame that supports the fuel tank, the internal combustion engine, the generator, and the surge protector.

4. The battery-operated vehicle of claim 3, wherein the support frame is adapted to be slidably received in a battery compartment in the battery-operated vehicle.

5. The battery-operated vehicle of claim 3, wherein the support frame has a footprint that substantially matches a footprint of the battery module.

6. The battery-operated vehicle of claim 1, wherein the surge protector is a battery.

7. The battery-operated vehicle of claim 6, wherein the battery only provides sufficient power to operate the electrical system of the battery-operated vehicle when the internal combustion engine is running.

8. The battery-operated vehicle of claim 1, wherein the surge protector includes at least two batteries connected in series.

9. The battery-operated vehicle of claim 1, wherein the surge protector continuously prevents a surge in power transferred from the generator to the electrical system of the battery-operated vehicle.

10. The battery-operated vehicle of claim 9, wherein the surge protector continuously prevents a surge in current transferred from the generator to the electrical system of the battery-operated vehicle.

11. The battery-operated vehicle of claim 9, wherein the surge protector continuously prevents a surge in voltage transferred from the generator to the electrical system of the battery-operated vehicle.

12. The battery-operated vehicle of claim 1, wherein the power produced by the power converter module is essentially a DC power supply.

13. The power converter module of the battery operated vehicle as claimed in claim 1.

14. A power converter module for a battery-operated vehicle, the power converter module being received in a battery compartment of the battery-operated vehicle, the power converter module comprising a support frame supporting a fuel tank, an internal combustion engine, a generator, and a surge protector, wherein the support frame is sized to have a footprint that substantially matches a footprint for a battery module swappable with the power converter module.

15. The power converter module of claim 14, wherein the surge protector includes a battery.

16. The power converter module of claim 14, wherein the power converter module provides power to an electrical system of the battery-operated vehicle in a manner substantially equivalent to the battery module.
